(19) United States
(12) Patent Application Publication
(10) Pub. No.: US 2010/0096304 A1
(43) Pub. Date: Apr. 22, 2010

(54) FUEL FILTER

(76) Inventors: Matthias Gänswein, Esslingen (DE); Peter Koppi, Wolfsberg (AT); Pia Küsgens, Stuttgart (DE); Sven Siegle, Stuttgart (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/438,248

(22) PCT Filed: Aug. 22, 2007
(86) PCT No.: PCT/EP2007/058703

§ 371 Date: Nov. 9, 2009

(30) Foreign Application Priority Data
Aug. 23, 2006 (DE) 10 2006 039 581.6

(51) Int. Cl. F02M 37/22; B01D 29/56; B01D 29/60; B01D 29/92; B01D 35/157

(52) U.S. Cl. 210/86; 210/255; 210/117; 210/138

(57) ABSTRACT

The invention relates to a fuel filter (1) with a filter element (2) for separating particles and water out of a fuel flow flowing through the fuel filter (1), a collecting space (6) for collecting the separated water (7), and a dewatering device (3) for discharging the separated water (7) out of the fuel filter (1). Here, it is essential to the invention that the dewatering device (3) has a hydrocarbon adsorber (9) for adsorbing hydrocarbon components which are entrained in the separated water (7).

The invention relates to a fuel filter having a filter element for separating particles and water out of a fuel stream flowing through the fuel filter according to the preamble of Claim 1.

To be able to achieve the highest possible efficiency of the internal combustion engine, a fuel filter is usually provided in a fuel line to filter dirt particles in particular out of the fuel and separate water entrained in the fuel. The possibility cannot be completely ruled out that fuel components are still present in the water separated from the fuel, so this water cannot be discharged directly into the environment but instead any amount of fuel still present in it must be removed.

One possibility for separation of fuel still present in separated water is known from DE 10 2005 000 658.2 A1, which describes a fuel filter having a filter element for filtering particles and water out of a fuel stream flowing through the fuel filter, and a dewatering device so that the water thereby filtered out can be removed from the fuel filter. The dewatering device is designed as an independent component and may optionally be separated from the filter element. A membrane that is semipermeable for water and rests flatly on a carrier, preventing the passage of fuel components, is provided in the dewatering device. Fuel components still present in the separated water are separated by the semipermeable membrane.

The invention relates to the problem of providing an improved embodiment or at least a different embodiment of a fuel filter of the generic type, such that it will allow especially simple and effective separation of fuel components still present in the separated water.

This problem is solved by a fuel filter having all the features of Patent Claim 1. Advantageous and expedient embodiments are the subject matter of the dependent subclaims.

The invention is based on the general idea of separating the hydrocarbons physically with the help of a filter from the separated water, then adsorbing the hydrocarbons and thereby separating them out of the separated water. To this end, a dewatering device that serves to remove the separated water from the fuel filter has a hydrocarbon adsorber capable of adding the hydrocarbons entrained in the separated water on its internal surface, i.e., adsorbing the hydrocarbons there. The principle here is that the greater the internal surface area of the adsorbent, the greater is the adsorption effect and/or adsorption capacity and the greater is the cleaning effect of the hydrocarbon adsorber. Such hydrocarbon adsorbers can be manufactured today inexpensively and in almost any form and, depending on the size of their internal surfaces and/or the flow-through rate, these ensure a high adsorption capacity and thus a great cleaning effect which is in any case sufficient to be able to discharge the water purified by the absorber into environment unobjectionably.

The hydrocarbon adsorber is expediently activated carbon or at least contains activated carbon. Activated carbon is a fine-grained carbon with an extremely large surface area and a highly porous structure. Its adsorption capacity is therefore especially high and is especially pronounced for hydrocarbons in particular, so that it is already widely used in filter systems, e.g., in exhaust air filters of tank systems. Furthermore, activated carbon can be manufactured in virtually any form and is also inexpensive, so that effective separation of the hydrocarbon components remaining in the separated water by a method that is also inexpensive in comparison with the state of the art can be achieved.

In an advantageous further embodiment of the inventive approach, a first switchable valve is arranged between a collecting space for separated water and the dewatering device, said valve being designed to be switchable manually, periodically or as a function of the degree of filling of the collecting space and therefore controlling the drainage of separated water out of the collecting space. It is conceivable here that the switchable valve is usually closed and is either opened manually or automatically at certain intervals. Manual operation of the switchable first valve can be initiated by a warning signal generated on a control board, for example, but it is also conceivable that this warning signal, which is generated on reaching a certain degree of filling of the collecting space, for example, causes automatic opening of the first valve and therefore supplies the water that has been separated from the fuel and collected in the collecting space to the hydrocarbon adsorber. This list shows that there are different possibilities with regard to draining out the separated water from the collecting space, so that the inventive fuel filter may be used in different variants.

An advantageous exemplary embodiment that is explained in greater detail below is diagrammed schematically in the drawing.

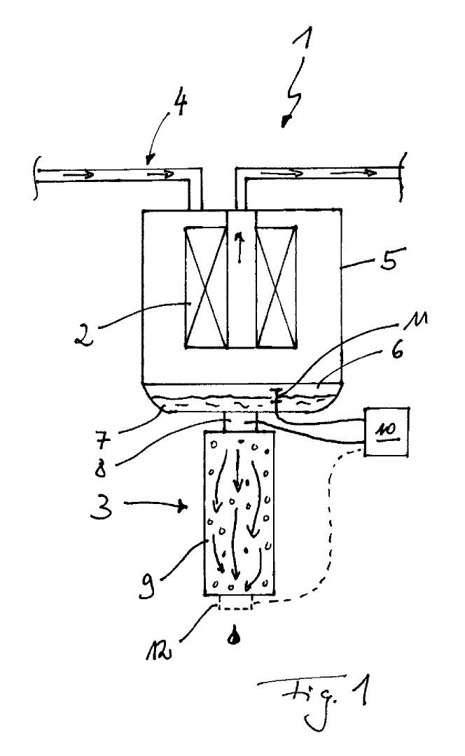

FIG. 1 is the only FIGURE, showing a sectional diagram of the inventive fuel filter.

According to FIG. 1, an inventive fuel filter 1 has a fuel element 2 and a dewatering device 3. The dewatering device 3 may be designed either as a unit together with the fuel filter 1 or as a separate module. The fuel filter 1 is usually connected to a fuel line 4 and is designed for separating particles and water 7 from a fuel stream flowing through the fuel filter 1. The filter element 2 may be designed as a filter cartridge and may also be detachably connected to a housing 5 of the fuel filter 1, so that it can be replaced easily.

Beneath the filter element 2, a collecting space 6 is provided for collecting water 7 separated from the fuel stream. An outlet with a switchable first valve 8 is arranged at a low point in the collecting space 6, said valve, in the opened state, connecting the collecting space 6 to the dewatering device 3 downstream from the collecting space 6. According to the invention, the dewatering device 3 has a hydrocarbon adsorber 9 for adsorption of hydrocarbons entrained in the separated water 7. When the first valve 8 is opened, the water 7 that has been separated from the fuel and collected in the collecting space 6 thus flows through the hydrocarbon adsorber 9 in which the hydrocarbon fractions remaining in the water 7 are filtered out. The water 7, which is now clean, can be discharged into the environment downstream from the hydrocarbon adsorber 9.

The hydrocarbon adsorber preferably is or at least contains activated carbon. Activated carbon consists primarily of carbon (mostly >90%) with a strongly porous structure. In addition, the internal surface area of the activated carbon is between 500 and 2000 m²/g carbon, which explains the high adsorption capacity of the activated carbon. The hydrocarbon adsorber 9 is preferably designed so that the water 7 flowing through it remains in the hydrocarbon adsorber 9 as long as possible, so that as much hydrocarbon as possible is removed from the separated water 7 on the activated carbon and/or on the hydrocarbon adsorber 9. The adsorption capacity may be used as a characteristic quantity for the filter effect of the hydrocarbon adsorber 9. Other adsorbents, e.g., zeolites, metal organic frameworks or other nonpolar adsorbents may of course also be used as the hydrocarbon adsorber 9.

The first switchable valve 8 arranged between the collecting space 6 for separated water 7 and the dewatering device 3 may be designed to be switchable manually, periodically or as a function of the degree of filling of the collecting space 6 and may therefore control the discharge of separated water 7 out of the collecting space 6. It is conceivable here that the valve 8 may be opened or closed manually from time to time or periodically via a control unit 10, i.e., opened and/or closed at certain intervals of time.

If the first valve 8 is switched as a function of the degree of filling of the collecting space 6, then a water level sensor 11 is preferably provided to detect this degree of filling, said water level sensor being designed to transmit the degree of filling prevailing in the collecting space 6 to control unit 10. It is conceivable here for the water level sensor 11 to be designed as a “two-level” sensor, for example, which detects at least two degrees of filling of the collecting space 6 and transmits them to the control unit 10. It is of course also conceivable for two water lever sensors 11 to be provided, one of which detects an upper degree of filling and the other detects a lower degree of filling of the collecting space 6 and transmits it to the control unit 10. If the degree of filling of the collecting space 6 reaches an upper limit value, then a signal is transmitted from the water level sensor 11 to the control unit 10, subsequently opening the first valve 8, so that water 7 can flow into the dewatering device 3 and/or through the hydrocarbon adsorber 9. The first valve 8 preferably remains open until the degree of filling in the collecting space 6 reaches a lower limit, whereupon the water level sensor 11 transmits a corresponding signal to the control unit 10, which then closes the first valve 8.

FIG. 1 shows the water level sensor 11 arranged in the area of the bottom of the collecting space 6, whereby it is also conceivable for the water level sensor 11 to be immersed in the collecting space 6 from above through the filter element 2.

In general, the hydrocarbon adsorber 9 may be designed to be so large that it has the same lifetime as the fuel filter 1 or is easily exchangeable, e.g., via a screw connection, and is connected to the fuel filter 1, so that it can be replaced easily as needed, with little maintenance effort. The lifetime should be designed for approximately 1 to 1.5 million kilometers and/or 15 years, if possible, in terms of the installation space. If the required installation space for this is not available, the hydrocarbon adsorber 9 is preferably exchanged in an n-fold filter change interval.

According to FIG. 1, a second switchable valve 12, which is designed to be switchable like the first valve 8, either manually, periodically or as a function of the first valve 8, is arranged downstream from the hydrocarbon adsorber 9. The arrangement of the second valve 12 has the great advantage that the dwell time of the water 7 in hydrocarbon adsorber 9 can be prolonged because the water 7 is prevented from flowing out of the hydrocarbon adsorber 9 when the valve 12 is closed. Since a long dwell time of the water 7 in the hydrocarbon adsorber 9 has a positive effect on the cleaning of the water 7, such a second valve 12 can definitely increase the cleaning effect, thus further reducing environmental pollution due to hydrocarbon residues still present in the water 7. The first valve 8 and/or the second valve 12 may be designed as solenoid valves, for example, and may be connected to the control line 10 for switching via corresponding electric lines. The use of the second valve 12 is optional, so this is represented by an interrupted line in FIG. 1. In general, the second valve 12 also serves as additional security in the event the first valve 8 does not close reliably. The first and second valves 8, 12 thus form a redundant system.

As shown in FIG. 1, the dewatering device 3 is arranged beneath the filter element 2 and/or at the bottom of the fuel filter 1, so the water 7 that is separated can be drained out in the absence of pressure merely by the force of gravity. However, it is also conceivable that, with another alternative arrangement of the dewatering device 3 with respect to the filter element 2, a fuel pump (not shown) is turned on for draining out the water that has been separated, thereby allowing the separated water 7 to drain out under pressure.

In general, with all possible embodiments, the longest possible dwell time of the separated water 7 in the hydrocarbon adsorber 9 should be the goal, and this can be achieved either by a corresponding geometric design of the hydrocarbon adsorber 9 and/or by the second valve 12 described above.

All the features defined in the description and described in the following claims may be essential to the invention, either individually or combined in any form together.

1. A fuel filter, comprising
a filter element separating particles and water out of a fuel stream flowing through the fuel filter,
a collecting space collecting separated water from the fuel filter; and
a dewatering device removing separated water from the fuel filter, such that the dewatering device is one of a unit together with the fuel filter and a separate module from the fuel filter,
wherein the dewatering device has a hydrocarbon adsorber adsorbing hydrocarbons entrained in separated water from the fuel filter.

2. The fuel filter according to claim 1, wherein one of the following is selected:
i. the hydrocarbon adsorber is activated carbon;
ii. the hydrocarbon adsorber contains activated carbon, and
iii. the hydrocarbon adsorber has one of the following:
a. zeolites,
b. a metal organic framework; and
c. nonpolar adsorbents.

3. The fuel filter according to claim 1, wherein a first switchable valve is switchable by one of manually, periodically and as a function of the degree of filling of the collecting space, where the first switchable valve is arranged between the collecting space collecting separated water from the fuel filter and the dewatering device, thereby controlling the discharge of separated water out of the collecting space.

4. The fuel filter according to claim 3, wherein a water level sensor determines the degree of filling of the collecting space, such that the water level sensor opens and closes at least the first switchable valve situated between the fuel filter and the dewatering device as a function of the degree of filling of the collecting space and thereby controls the discharge of separated water from the fuel filter out of the collecting space.

5. The fuel filter according to claim 4, wherein the water level sensor is a two-level sensor.

6. The fuel filter according to claim 1, wherein at least one of the following is selected:
i. a supply of hydrocarbon adsorbent is tailored to the lifetime of the fuel filter, and
ii. the hydrocarbon adsorber is replaceable.

7. The fuel filter according to claim 3, wherein a second switchable valve is one of switchable manually, periodically and as a function of a first valve, and the second switchable valve is provided downstream from the hydrocarbon adsorber and thereby controls a dwell time of separated water from the fuel filter contaminated with hydrocarbons in the hydrocarbon adsorber.

8. The fuel filter according to claim 1, wherein one of the following is selected:
i. the dewatering device is arranged beneath the fuel filter in such a way that separated water from the fuel filter is drained out without pressure by the force of gravity, and
ii. a fuel pump is configured for being switched to drain out separated water from the fuel filter under the influence of pressure.

9. The fuel filter according to claim 2, wherein a first switchable valve is switchable by one of manually, periodically and as a function of the degree of filling of the collecting space, where the first switchable valve is arranged between the collecting space collecting separated water from the fuel filter and the dewatering device, thereby controlling the discharge of separated water out of the collecting space.

10. The fuel filter according to claim 9, wherein a water level sensor determines the degree of filling of the collecting space, such that the water level sensor opens and closes at least the first switchable valve situated between the fuel filter and the dewatering device as a function of the degree of filling of the collecting space and thereby controls the discharge of separated water from the fuel filter out of the collecting space.

11. The fuel filter according to claim 10, wherein the water level sensor is a two-level sensor.

12. The fuel filter according to claim 2, wherein at least one of the following is selected:
i. a supply of hydrocarbon adsorbent is tailored to the lifetime of the fuel filter, and
ii. the hydrocarbon adsorber is replaceable.

13. The fuel filter according to claim 4, wherein a second switchable valve is one of switchable manually, periodically and as a function of a first valve, and the second switchable valve is provided downstream from the hydrocarbon adsorber and thereby controls a dwell time of separated water from the fuel filter contaminated with hydrocarbons in the hydrocarbon adsorber.

14. The fuel filter according to claim 2, wherein one of the following is selected:
i. the dewatering device is arranged beneath the fuel filter in such a way that separated water from the fuel filter is drained out without pressure by the force of gravity, and
ii. a fuel pump is configured for being switched to drain out separated water from the fuel filter under the influence of pressure.

15. The fuel filter according to claim 3, wherein at least one of the following is selected:
i. a supply of hydrocarbon adsorbent is tailored to the lifetime of the fuel filter, and
ii. the hydrocarbon adsorber is replaceable.

16. The fuel filter according to claim 5, wherein a second switchable valve is one of switchable manually, periodically and as a function of a first valve, and the second switchable valve is provided downstream from the hydrocarbon adsorber and thereby controls a dwell time of separated water from the fuel filter contaminated with hydrocarbons in the hydrocarbon adsorber.

17. The fuel filter according to claim 3, wherein one of the following is selected:
i. the dewatering device is arranged beneath the fuel filter in such a way that separated water from the fuel filter is drained out without pressure by the force of gravity, and
ii. a fuel pump is configured for being switched to drain out separated water from the fuel filter under the influence of pressure.

18. The fuel filter according to claim 4, wherein at least one of the following is selected:
i. a supply of hydrocarbon adsorbent is tailored to the lifetime of the fuel filter, and
ii. the hydrocarbon adsorber is replaceable.

19. The fuel filter according to claim 6, wherein a second switchable valve is one of switchable manually, periodically and as a function of a first valve, and the second switchable valve is provided downstream from the hydrocarbon adsorber and thereby controls a dwell time of separated water from the fuel filter contaminated with hydrocarbons in the hydrocarbon adsorber.

20. The fuel filter according to claim 4, wherein one of the following is selected:
i. the dewatering device is arranged beneath the fuel filter in such a way that separated water from the fuel filter is drained out without pressure by the force of gravity, and
ii. a fuel pump is configured for being switched to drain out separated water from the fuel filter under the influence of pressure.
